(19) United States
(12) Patent Application Publication
(10) Pub. No.: US 2026/0240722 A1
(43) Pub. Date: Aug. 20, 2026

(54) DEVICE INCLUDING A LIQUID RESERVOIR FOR TREATING FINGERS OR PART OF A HAND

(71) Applicants: Bradley Scott BERNDT, Findlay, OH (US); Gary L. HIMMEL, Fairlawn, OH (US); Erik WHITE, Copley, OH (US); James W. ILER, Lafayette, LA (US)

(72) Inventors: Bradley Scott BERNDT, Findlay, OH (US); Gary L. HIMMEL, Fairlawn, OH (US); Erik WHITE, Copley, OH (US); James W. ILER, Lafayette, LA (US)

(21) Appl. No.: 19/164,431

(22) PCT Filed: Mar. 12, 2024
(86) PCT No.: PCT/US2024/019480

§ 371 Date: Sep. 11, 2025

Related U.S. Application Data
(60) Provisional application No. 63/451,748, filed on Mar. 13, 2023.

(51) Int. Cl. A61H 35/00

(52) U.S. Cl. CPC A61H 35/00; A61H 2201/0192; A61H 2201/105; A61H 2201/1638; A61H 2205/067

(57) ABSTRACT

A device for treating distal extremities of the hand such as lacerations, burns, injuries, infections, etc., with a liquid treatment solution. The device includes a reservoir for holding the liquid treatment solution and a ramp connected thereto that is adapted to serve as a support for a user's forearm. The device is designed such that the user's hand knuckles and fingers are able to soak in the liquid treatment solution without contacting the base or side of the reservoir, thereby providing thorough all-surface treatment, while being supported in ergonomically comfortable position for prolonged treatment.

### FIELD OF THE INVENTION

The present invention relates to a device for treating distal hand injuries. with a liquid treatment solution. The device includes a reservoir for holding the liquid treatment solution and a ramp hinged connected thereto that is adapted to serve as a rest for a user's forearm. The device is designed such that the user's hand and digits are able to soak in the liquid treatment solution without contacting the base or side of the reservoir, thereby providing thorough all-surface treatment.

### BACKGROUND OF THE INVENTION

Many different devices have been proposed in the art for soaking parts of finger tips and/or nails in a liquid that is used for cosmetic or therapeutic purposes. Certain devices include reservoirs for holding the liquid. Some of the devices also provide structure for restful support of one or more of the fingers, hand, and the wrist.

Examples of devices that have been proposed in the art include those set forth in U.S. Pat. Nos. 2,169,990; 2,245,929; 2,561,001; 2,580,981; 2,816,556; 4,441,487; 6,695,800; and 9,788,630; Japanese Patent No. 2006311892; and WO 2016043042.

While the referenced prior art discloses different means for providing liquid treatment to the fingers there remains room for additional improvements. For example, the need remains for a device that is able to treat all surfaces of individual fingers and/or parts of the hand submerged in the liquid for prolonged periods with arm support. There also remains a need for a treatment device that minimizes the amount of treatment liquid required and reduces medical/environmental waste. The device of the present invention meets the above needs, and more as further detailed herein.

### SUMMARY OF THE INVENTION

In view of the above, a device for treating a portion of the hand including individual fingers and knuckles with a liquid treatment solution is disclosed, wherein the device includes a reservoir for holding the liquid treatment solution and a ramp hingedly connected thereto which serves as a rest for the user's forearm. The structure of the device allows the user's hand, knuckles, and fingers to soak in the liquid uninhibited from contact with the base or the side of the reservoir. The device allows for treating traumatic injuries such as lacerations, splinters, infections, burns, or the like with a sterilizing liquid solution.

In a further aspect of the invention, the device is constructed in order to minimize waste and facilitate recycling by constructing the same from a recyclable material.

In an additional aspect, the device advantageously is designed to be ambidextrous, thus allowing for use with either the left hand or the right hand.

In yet another aspect, the ramp helps minimize or eliminate pain for users that have conditions such as arthritis, by allowing the forearm to rest on the ramp while leaving the wrist free to hang downward in a natural position.

In still another aspect, the ramp is adjustable about a hinged connection to the reservoir to accommodate alternative angles of entry into the liquid reservoir while maintaining arm support.

In a further aspect of the invention, the arm support ramp is designed to allow the wrist to move unobstructed, permitting the fingers to dangle, allowing all 360° thereof to be exposed to the solution in the treatment reservoir. Thus, the device is comfortable to use for an extended amount of time in order to provide adequate treatment.

For the avoidance of doubt, it is understood that while various embodiments or aspects of the invention are described individually, it should be clear that two or more embodiments or aspects can, and oftentimes are present in a single device according to the present invention.

In view of the above, in one embodiment a device for treating fingers or part of a hand with a liquid is disclosed, comprising a non-tip reservoir for holding a treatment liquid, the reservoir having a base adapted to contact a surface upon which the device can be placed and an upper rim, with at least one sidewall extending therebetween, a ramp having a first end connected by hinge to the rim of the reservoir and a second end adapted to contact the surface upon which the device can be placed, wherein the first end of the ramp is located height-wise above the second end in a vertical direction, and wherein the first end is vertically higher than any other portion of the ramp.

In a further embodiment, a device for treating fingers or part of a hand with a liquid is disclosed, comprising a reservoir for holding a treatment liquid, the reservoir having a base adapted to contact a surface upon which the device can be placed and an upper rim, with at least one sidewall extending therebetween, a ramp having a first end operatively connected to the rim of the reservoir and a second end adapted to contact the surface upon which the device can be placed, wherein the first end of the ramp is located height-wise above the second end in a vertical direction, and wherein the first end is vertically higher than any other portion of the ramp.

### BRIEF DESCRIPTION OF THE DRAWINGS

The invention will be better understood and other features and advantages will become apparent by reading the detailed description of the invention, taken together with the drawings, wherein:

FIG. 1 is a front right perspective view of one embodiment of the device of the present invention including a reservoir for holding a liquid suitable for treating fingers or part of the hand and a ramp operatively connected thereto;

FIG. 2 is a right rear perspective view of the device in FIG. 1;

FIG. 3 is a left rear perspective view of the device illustrated in FIG. 1;

FIG. 4 is a side elevation of the device illustrated in FIG. 1;

FIG. 5 is a top plan view of the embodiment illustrated in FIG. 1;

FIG. 6 is a side view of one embodiment of the ramp of the device;

FIG. 7 is a front view of the ramp illustrated in FIG. 6;

FIG. 8 is a top plan view embodiment illustrated in FIG. 6;

FIG. 9 is a front right perspective view of one embodiment of the reservoir of the device;

FIG. 10 is an upper right side perspective view of the reservoir illustrated in FIG. 9; and

FIG. 11 is a left rear perspective view of the reservoir illustrated in FIG. 9.

### DETAILED DESCRIPTION OF THE INVENTION

This description of preferred embodiments is to be read in connection with the accompanying drawings, which are part of the entire written description of this invention. In the description, corresponding reference numbers are used throughout to identify the same or functionally similar elements. Relative terms such as “horizontal,” “vertical,” “up,” “upper”, “down,” “lower”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

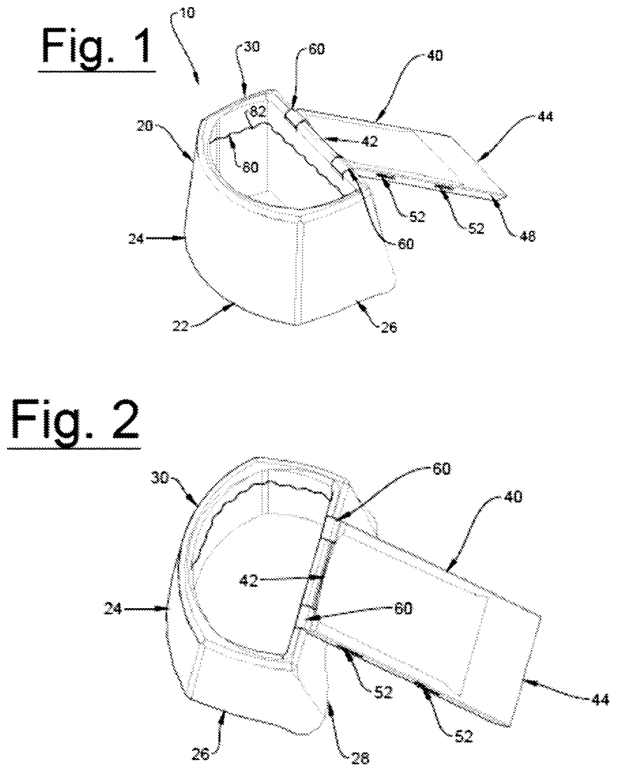

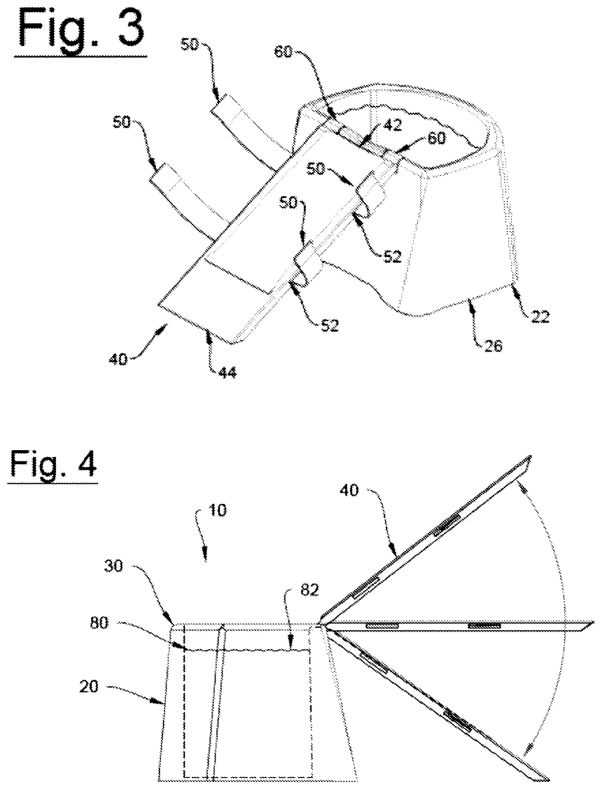

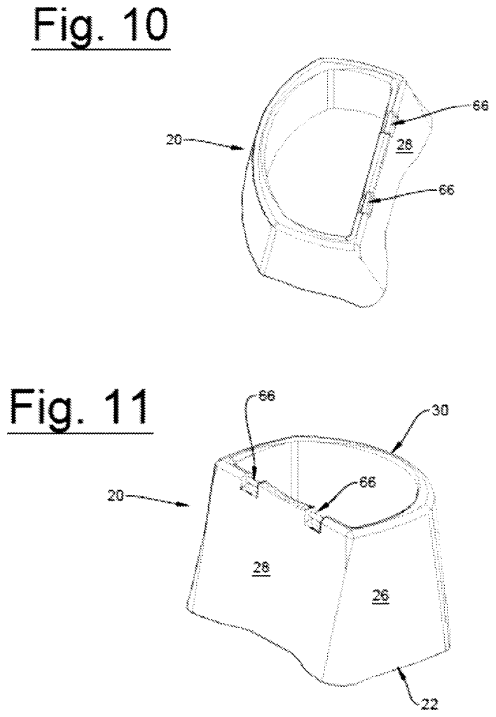

Referring now to the drawings, wherein the reference numerals represent the same or similar parts throughout the several views. FIGS. 1-3 illustrate perspective views of one embodiment of a device 10 for treating fingers or part of the hand with a liquid. The device includes a reservoir 20 for holding the treatment liquid, see FIGS. 9-11 for individual views of the reservoir 20. An example treatment liquid 80 is illustrated in FIG. 4. A suitable amount of the treatment liquid is utilized so that the upper surface 82 thereof is present at a desired height within reservoir 20.

The reservoir 20 has a base 22 and a height measured between the base 22 and an upper rim 30. The height of the reservoir 20 is sufficient such that the fingers on the part of the hand to be treated do not touch the upper surface of the base 22 when extended into reservoir 20. That said, in some embodiments, the reservoir has a height that ranges generally from about 4.5 to about 10 inches and preferably from about 6 to about 8 inches, with 6 inches being most preferred. As illustrated in the figures, reservoir 20 includes a front 24, a pair of sides 26 and a rear 28. However, it is to be understood that the reservoir can be formed in any other shapes so long as the functions described herein are met. Thus, the reservoir in other embodiments can have rounded sides or have a cross-sectional form such an oval, cylinder, semi-cylinder, rectangular prism or the like.

The reservoir 20 has a maximum width measured between the internal sides 26 sufficient to be able to have fingers or part of a hand inserted within the reservoir without touching the side surfaces. The maximum width of the reservoir ranges generally from about 5 to about 10 inches between the inner walls of the front and rear, 24 and 28 respectively, and preferably from about 6.5 to about 9 inches. An internal length of the reservoir measured perpendicular to the width, generally in a longitudinal direction of the ramp 40, is also of sufficient length such that the fingers or part of a hand do not contact the front 24 or rear 28 surfaces of reservoir 20. The length ranges generally from about 4 to about 10 inches and preferably from about 5.5 to about 8 inches. In a preferred embodiment of the invention, the maximum width of the reservoir is greater than a maximum length of the reservoir.

In an important aspect of the present invention, as shown in the drawings, reservoir 20 is free of any internal structure that would prevent the treatment liquid from contacting all surfaces of a desired finger or part of the hand. Stated another manner, the reservoir is free of each of a finger rest and hand rest for example as illustrated in the prior art of U.S. Pat. Nos. 2,169,990 and 4,441,487.

Ramp 40 is operatively and hingedly connected to upper rim 30 of reservoir 20 and has a longitudinal length that extends away from the rear 28 of reservoir 20. As illustrated in the side view of FIG. 4, the ramp has a first end 42 connected to upper rim 30 and a second end 44 adapted to rest upon a flat surface. Individual views of ramp 40 are shown in FIGS. 6-8.

The ramp is hinged to allow for adjustment of the ramp angle in relation to the reservoir.

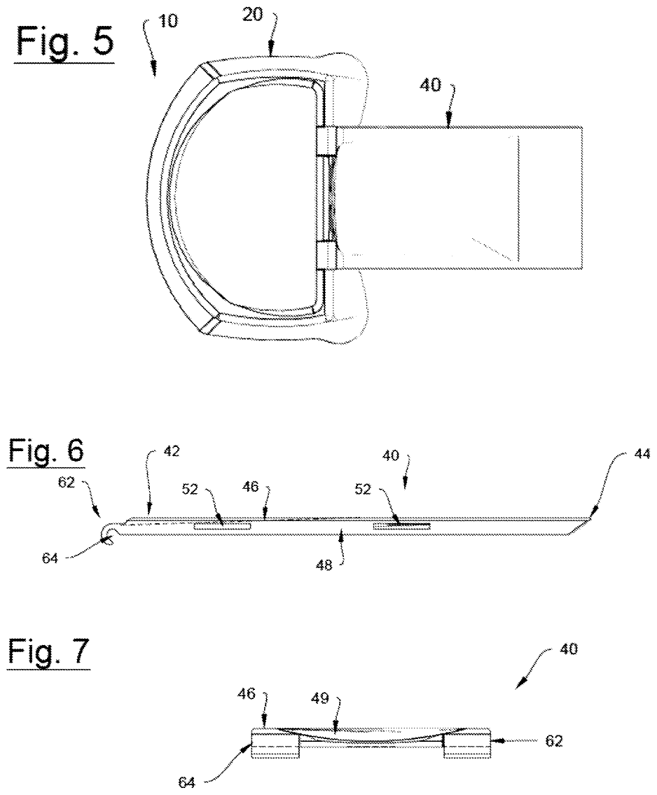

Hinge 60 operatively connects ramp 40 to reservoir 20 as illustrated in FIGS. 1-5. Hinge 60 includes a hinge arm 62 located at first end 42 of ramp 40. Hinge arm 62 includes a knuckle 64, which as shown in FIG. 6 is a semi-circular section that creates the joint of the hinge through which pin 66 of reservoir connects ramp 40 to reservoir 20. Pin 66 has a longitudinal axis about which the knuckle 64 and thus the hinge 60 itself rotates. Knuckle 64 is an open knuckle which allows removal of the ramp 40 from reservoir 20. Ramp 40 can be connected to reservoir 20 by inserting pin 66 into knuckle 64 through the opening therein, via a snap-fit connection.

Providing the ramp 40 and reservoir 20 with a hinged connection at hinge 60 allows a large range of motion to provide for comfort of a user. As illustrated in FIG. 4, ramp 40 can be situated at a multitude of different positions in relation to the reservoir.

In an important aspect of the present invention, first end 42 of ramp 40 does not extend past the upper end of rear wall 28 of reservoir 20. First end 42 of ramp 40 ends at the location where it is hingedly joined to rear 28 so that the ramp does not interfere nor support the fingers or a part of a hand in reservoir 20. First end 42 of ramp 40 is located height-wise above the second end 44 when considered in a vertical direction as illustrated in FIG. 4. The ramp has a sufficient length in order to support a desired portion of a wrist and/or a lower part of a forearm. With respect to a horizontal surface, the ramp has a longitudinal length that is disposed at an angle of generally from about 45° to about 60°, and preferably from about 50° to about 60°.

Obviously, the length of the ramp can vary depending upon the desired approach angle to the upper rim 30 of reservoir 20 when the second end 44 is resting on a horizontal surface. Said ramp length can range from a length of about 6 to about 16 inches and preferably from about 10 to about 12 inches. The first end of the ramp is vertically higher than any other portion of the ramp in a preferred embodiment.

The ramp has a width between sides 48 that is sufficient to support a portion of the forearm of the user. Accordingly, in various embodiments, the width of the ramp perpendicular to the longitudinal axis of the ramp ranges generally from about 3.5 to about 8 inches and preferably is about 4 to about 6.5 inches. If desired, padding or other user-comforting materials can be added to the upper surface 46 of ramp 40.

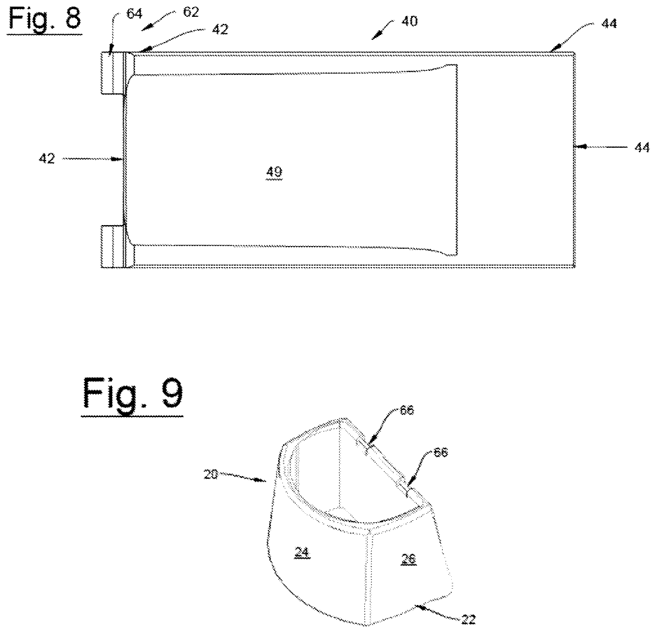

As illustrated in FIGS. 1-3 and particularly in FIGS. 7 and 8, ramp 40 include a curved, recessed central area 49. Central area 49 generally extends from first end 42 down to a lower end of the ramp 40 near second end 44. Central area 49 cradles the forearm of a user and aids in maintaining positioning of the forearm on the ramp. The central area 49 transitions from an inward curve at first end 42 of ramp 40 to a flat section at the lower end of the central area 49.

In a preferred embodiment of the invention, a forearm strap 50 is operatively connected to ramp 40 in order to maintain a desired position of the user's forearm in relation to the device 10. Ramp 40 includes wrist strap slots 52 in opposite sides of the ramp 40 to allow for forearm straps to secure the forearm to ramp 40. In one embodiment the straps are formed including Velcro® components in order to self-connect one end of the forearm strap to the other.

### Method of Use

In order to utilize the device, it is placed upon a preferably level surface. A treatment liquid is added to the reservoir to a sufficient height. The reservoir can contain markings, either inside or outside or both in order to indicate a sufficient height for the treatment liquid. Thereafter, a user's fingers or part of the hand are inserted into the liquid and the user's forearm are rested upon ramp 40. The user's fingers and/or part of a hand are suspended in the treatment liquid and do not contact any of the inside surfaces of the reservoir. When desired, the wrist strap can be connected about the user's forearm to aid in treatment.

In accordance with the patent statutes, the best mode and preferred embodiment have been set forth; the scope of the invention is not limited thereto, but rather by the scope of the attached claims.

What is claimed is:

1. A device for treating fingers or part of a hand with a liquid, comprising:
a reservoir for holding a treatment liquid, the reservoir having a base adapted to contact a surface upon which the device can be placed and an upper rim, with at least one sidewall extending therebetween,
a ramp having a first end hingedly connected to the rim of the reservoir and a second end adapted to contact the surface upon which the device can be placed,
wherein the first end of the ramp is located height-wise above the second end in a vertical direction, and
wherein the first end is vertically higher than any other portion of the ramp.

2. The device according to claim 1, wherein the ramp has a hinge arm including a knuckle wherein the reservoir upper rim includes at least one pin, wherein the knuckle rotatably connected to the pin such that the ramp is rotatably hingedly connected to the reservoir.

3. The device according to claim 2, wherein the pin is formed in the upper rim of the reservoir, and wherein the knuckle is semi-circular and has an opening allows the pin to be inserted into the knuckle.

4. The device according to claim 1, wherein the first end of the ramp does not extend into the reservoir.

5. The device according to claim 1, wherein the reservoir is free of a structure that is able to support one or more of the fingers and hand.

6. The device according to claim 1, wherein the ramp has an upper surface and two side surfaces, wherein the ramp includes a forearm strap having two portions independently connected to one or more of the upper surface at one of the two side surfaces, wherein the forearm strap is adapted to temporarily restrain and support the forearm of a user to the ramp upper surface.

7. The device according to claim 1, wherein the reservoir tapers outwardly in a direction from the upper rim to the base in at least one area of the reservoir, wherein when the device is placed on a level surface, the ramp extends at an angle between 40° and 60°.

8. The device according to claim 7, wherein the ramp angle is between 45° and 55°.

9. The device according to claim 1, wherein a height of the reservoir is about equal to a maximum length of the reservoir measured parallel to the longitudinal axis of the ramp.

10. A device for treating fingers or part of a hand with a liquid, comprising:
a reservoir for holding a treatment liquid, the reservoir having a base adapted to contact a surface upon which the device can be placed and an upper rim, with at least one sidewall extending therebetween,
a ramp having a first end operatively connected to the rim of the reservoir and a second end adapted to contact the surface upon which the device can be placed,
wherein the first end of the ramp is located height-wise above the second end in a vertical direction, and
wherein the first end is vertically higher than any other portion of the ramp.

11. The device according to claim 10, wherein the ramp has a hinge arm including a knuckle wherein the reservoir upper rim includes at least one pin, wherein the knuckle rotatably connected to the pin such that the ramp is rotatably hingedly connected to the reservoir.

12. The device according to claim 11, wherein the pin is formed in the upper rim of the reservoir, and wherein the knuckle is semi-circular and has an opening allows the pin to be inserted into the knuckle.

13. The device according to claim 12, wherein the ramp has an upper surface and two side surfaces, wherein the ramp includes a forearm strap having two portions independently connected to one or more of the upper surface at one of the two side surfaces, wherein the forearm strap is adapted to temporarily restrain and support the forearm of a user to the ramp upper surface.

14. The device according to claim 12, wherein the pin is formed in the upper rim of the reservoir, and wherein the knuckle is semi-circular and has an opening allows the pin to be inserted into the knuckle.

15. The device according to claim 14, wherein the ramp has an upper surface and two side surfaces, wherein the ramp includes a forearm strap having two portions independently connected to one or more of the upper surface at one of the two side surfaces, wherein the forearm strap is adapted to temporarily restrain and support the forearm of a user to the ramp upper surface.

16. The device according to claim 15, wherein the reservoir tapers outwardly in a direction from the upper rim to the base in at least one area of the reservoir, wherein when the device is placed on a level surface, the ramp extends at an angle between 40° and 60°.

17. The device according to claim 16, wherein the ramp angle is between 45° and 55°.

18. The device according to claim 17, wherein a height of the reservoir is about equal to a maximum length of the reservoir measured parallel to the longitudinal axis of the ramp.
